(19) United States
(12) Patent Application Publication
(10) Pub. No.: US 2019/0204159 A1
(43) Pub. Date: Jul. 4, 2019

(54) APPARATUS AND METHOD FOR PRODUCING THERMAL IMAGE DATA

(71) Applicant: The University of Sheffield, Sheffield South Yorkshire (GB)

(72) Inventor: Jonathan Raffe Willmott, Sheffield South Yorkshire (GB)

(73) Assignee: The University of Sheffield, Sheffield South Yorkshire (GB)

(21) Appl. No.: 16/295,143

(22) Filed: Mar. 7, 2019

Related U.S. Application Data
(63) Continuation of application No. PCT/GB2017/052630, filed on Sep. 8, 2017.

(30) Foreign Application Priority Data
Sep. 9, 2016 (GB) 1615323.1

(51) Int. Cl. G01J 5/28; G02B 26/08; G02B 26/10; G01J 5/08; H04N 5/33

(52) U.S. Cl. CPC G01J 5/28; G02B 26/0833; G01J 2005/0077; G01J 5/0809; H04N 5/33; G02B 26/101

(57) ABSTRACT

A thermal imaging device is provided, comprising: a detector for receiving radiation and outputting a detector signal corresponding thereto; a steerable mirror device arranged in relation to the detector; wherein the steerable mirror device is steerable to scan an entrance pupil over a plurality of locations such that the detector outputs respective detector signals indicative of temperatures of respective portions of the object corresponding to the locations of the entrance pupil, and wherein the thermal imaging device is configured to provide a substantially constant etendue for all of the entrance pupil locations of the plurality of entrance pupil locations.

### CROSS-REFERENCES TO RELATED APPLICATIONS

This application claims priority to and is a continuation of International Patent Application No. PCT/GB2017/052630, filed Sep. 8, 2017; which claims priority from GB Patent Application No. 1615323.1, filed Sep. 9, 2016, the entire contents of which are hereby incorporated by reference in their entirety for all purposes.

### BACKGROUND OF THE INVENTION

Non-contact temperature measurement is employed in many applications, such as in hazardous environments or where objects are physically inaccessible. A radiation thermometer receives radiation, typically infra-red, from an object and determines a surface temperature of a measurement spot on the object's surface. The received radiation is directed to a sensor within the radiation thermometer. The temperature of the object within the measurement spot may be accurately determined by the radiation thermometer. For example, such a radiation thermometer may be used in steel production to measure a temperature of steel being output from a steel mill, although this is only one example application.

A thermal imaging camera is a device which produces thermal image data of an object. The thermal image data represents the spatial temperature of the object i.e. the temperature of the object against location about the object. Such thermal imaging cameras include a pixelated detector which comprises a plurality of pixels arranged in at least one, and more commonly two, dimensions which each provide a signal indicative of a temperature of a respective portion of the object. However thermal imaging cameras are relatively inaccurate at determining the temperature of the object.

Single pixel thermal imaging devices exist which use scanning mirrors to scan a scene over time to thereby sequentially select different portions of the object onto the same pixel. Such devices can be made less expensively and are easier to calibrate than pixelated detectors. However, conventional single pixel thermal imaging devices have relatively large mirrors which are rotated about one or more axes by motors and are therefore inherently large, bulky and power hungry.

It is an object of embodiments of the invention to at least mitigate one or more of the problems of the prior art.

### BRIEF SUMMARY OF THE INVENTION

A first aspect of the invention provides a thermal imaging device, comprising:
a detector for receiving (typically electromagnetic, typically infrared) radiation and outputting a detector signal corresponding thereto;
a steerable mirror device arranged in relation to the detector (the steerable mirror device typically being configured to reflect incoming radiation onto the detector);
wherein the mirror device is steerable to control a location of an entrance pupil (typically the entrance pupil of the thermal imaging device) such that the detector outputs the detector signal indicative of a temperature of a portion of the object corresponding to the location of the entrance pupil.

It may be that the steerable mirror device is arranged in relation to the detector to form an aperture stop. Alternatively an aperture stop separate from the steerable mirror device may be provided. In this case, the aperture stop and the mirror device are typically configured such that a (theoretical) maximum cone of radiation which can be received and reflected onto the detector by the mirror device covers over 70% of the surface area of a reflective surface of the mirror device, preferably over 80% of the surface area of the reflective surface of the mirror device, in some cases over 90% of the surface area of the reflective surface of the mirror device, preferably less than 100% of the surface area of the reflective surface of the mirror device. Typically the said maximum cone of radiation does not cover edge portions of the reflective surface of the mirror device, to thereby avoid edge effects. However, the greater the portion of the surface area of the reflective surface of the mirror covered by the said cone, the greater the signal to noise ratio of the signal detected by the detector.

Typically the mirror device is steerable to thereby scan the entrance pupil through a plurality of locations at which the thermal imaging device is configured to obtain detector signals to thereby generate a thermal image of an object. Typically the mirror device is steerable to scan the location of the entrance pupil over a plurality of locations such that the detector outputs respective detector signals indicative of temperatures of respective portions of the object corresponding to the said locations of the entrance pupil. It may be that the detector is configured to output detector signals in response to radiation received by the thermal imaging device at each of the respective entrance pupil locations of the said plurality, the detector signals being indicative of a temperature of a portion of the object corresponding to the respective location of the entrance pupil.

Typically the thermal imaging device is configured to provide a substantially constant etendue (e.g. the thermal imaging device may be configured to provide an etendue which deviates from a mean etendue by less than 10%, preferably by less than 5%, preferably by less than 1%, preferably by 0% (i.e. preferably a constant etendue)) for all of the entrance pupil locations of the said plurality of entrance pupil locations (i.e. the thermal imaging device is configured such that the etendue of the thermal imaging device is substantially the same for each of the entrance pupil locations of the said plurality of entrance pupil locations).

Typically the thermal imaging device is configured to generate a thermal image (typically against location) from the detector signals. Typically the thermal imaging device is configured to output the said thermal image (e.g. on a display).

Typically the mirror device has a steerable range which defines the possible range of steering positions of the mirror device. It may be that the thermal imaging device is configured to steer the mirror device over at least 50%, more preferably at least 70%, more preferably at least 90%, most preferably 100% of its steerable range (or of its steerable range whilst still facing the objective) in order to scan the entrance pupil over the said plurality of locations.

It may be that the said plurality of locations of the entrance pupil together provide the thermal imaging device with a horizontal angle of view of at least 10° (more preferably at least 20°, even more preferably at least 30°, yet more preferably more than 40°) and/or with a vertical angle of view of at least 10° (more preferably at least 20°, even more preferably at least 30°, yet more preferably more than 40°).

Typically the thermal imaging device comprises an objective. Typically the objective is configured to collect incoming radiation from the object and to direct a portion thereof (typically directly from the objective) onto the steerable mirror device. Typically the objective is configured to converge the collected radiation (typically to provide a cone of collected radiation) such that a portion thereof is directed onto the steerable mirror device. It may be that the objective comprises one or more optical elements, such as one or more lenses. It may be that the objective comprises an objective lens. Typically the mirror device is configured to reflect radiation received from the objective onto the detector.

It may be that the thermal imaging device has a field stop (which may for example be provided by the detector or by an aperture (e.g. a mechanical aperture) provided over the detector). It may be that the thermal imaging device is (typically the objective, the mirror device and the field stop are) configured such that the solid angle of the (e.g. exit aperture of the) objective from the field stop is greater than the solid angle of the mirror device from the field stop. Typically, for each of the said plurality of entrance pupil locations, the solid angle of the mirror device from the field stop (or a projection of the solid angle of the mirror device from the field stop onto an exit aperture of the objective through which collected radiation leaves the objective, typically along the principal optical axis of the (typically theoretical) maximum cone of radiation which can be received and reflected onto the detector by the mirror device) is within (and typically does not fill) an (or the) exit aperture of the objective (through which received radiation leaves the objective), typically to thereby maintain a substantially constant etendue for all entrance pupil locations of the said plurality.

Typically the mirror device has a lower etendue than the objective.

Typically the entrance pupil of the thermal imaging device has a smaller area than an entrance aperture of the objective.

It may be that the thermal imaging device is (typically the objective and the mirror device are) configured such that a half angle of a (typically theoretical) maximum cone of collected radiation which can be provided by the objective (typically independent of the mirror device) is greater than a half angle of a (typically theoretical) maximum cone of radiation which can be received and reflected onto the detector (reflected onto the detector by the mirror device directly or by way of one or more focusing lenses and/or by way of an aperture stop of the thermal imaging device, where provided) by the mirror device (typically independent of the objective).

Typically the thermal imaging device is (typically the objective and the mirror device are) configured such that a (typically theoretical) maximum cone of radiation which can be received and reflected by the mirror device onto the detector (typically independent of the objective) is within a (typically theoretical) maximum cone of collected radiation which can be provided by the objective (typically independent of the mirror device) for each entrance pupil location of the said plurality of entrance pupil locations (typically to thereby maintain substantially constant etendue for all entrance pupil locations of the said plurality).

By configuring the thermal imaging device to provide a substantially constant etendue (e.g. by configuring the thermal imaging device such that a (typically theoretical) maximum cone of radiation which can be received and reflected by the mirror device onto the detector (typically independent of the objective) is within a (typically theoretical) maximum cone of collected radiation which can be provided by the objective (typically independent of the mirror device)) for all of the entrance pupil locations of the said plurality, vignetting is prevented and the thermal imaging device can thus form radiometrically accurate thermal images of the object for all entrance pupil locations of the said plurality of entrance pupil locations, thereby allowing the thermal imaging device to perform accurate quantitative temperature measurements of a plurality of portions of the object being imaged.

Typically the thermal imaging device is configured to quantitatively measure the temperature of at least a portion of (typically each of a plurality of portions of) an object being imaged, typically from the said detector signals.

It may be that the thermal imaging device comprises an optical system comprising the mirror device. Typically the optical system further comprises the objective. Typically the optical system further comprises the detector.

It may be that the thermal imaging device is configured to provide a substantially constant etendue (or optical throughput) of the optical system for all entrance pupil locations of the said plurality of entrance pupil locations.

It may be that the mirror device is steered by rotation of the mirror about one or more axes, but more typically the mirror device is steered by tilting the mirror device about an axis or (typically independently) about each of two orthogonal axes. It may be that the mirror device is configured to be tilted to a desired angle or direction by an electric field exerted on the mirror device. By tilting (rather than rotating) the mirror device, it can be ensured that the mirror device constantly images the object. Providing a mirror device which steers by tilting (typically by application of an electric field to the mirror device) rather than by rotation also allows the mirror device to continuously move the entrance pupil of the thermal imaging device between the said entrance pupil locations (rather than having to “stop and stare” at each of the pupil locations, which can be required if for example a step motor was used to rotate a scanning mirror between respective discrete locations). This permits faster scanning of the object, enabling faster imaging. Accordingly, it may be that the thermal imaging device is configured to continuously steer the mirror device to thereby continuously scan the entrance pupil between the entrance pupil locations of the said plurality of entrance pupil locations.

It may be that the thermal imaging device comprises a control unit arranged to control the detector to output a sequence of detector signals each indicative of the temperature of a respective portion of the object corresponding to a plurality of positions of the entrance pupil.

It may be that the control unit is arranged to steer the mirror device to scan the location of the entrance pupil amongst the plurality of positions.

It may be that the thermal imaging device comprises:
a steering device arranged to steer the mirror device responsive to a steering signal;
a control unit arranged to output the steering signal and a detector control signal, such that the detector outputs a first detector signal indicative of the temperature of the object with the entrance pupil at a first location and a second detector signal indicative of the temperature of the object with the entrance pupil at a second location.

It may be that the thermal imaging device comprises a lens, wherein the mirror device is steerable to control the location of the entrance pupil upon the lens.

It may be that the detector is a single-pixel detector.

It may be that the detector is a photodiode.

It may be that the detector is an avalanche photodiode.

It may be that the mirror device has (or is configured to reflect radiation onto the detector over) a diameter of less than 10 mm, more typically less than 6 mm, more typically less than 5.5 mm, more typically less than 4 mm. It may be that the mirror device is a microelectromechanical mirror. It will be understood that microelectromechanical mirrors are small, light-weight and portable and that they can be steered quickly and continuously by application of an electric field thereto to tilt the said microelectromechanical mirror. In addition, the resolution of the thermal imaging device can be increased by using a smaller (e.g. microelectromechanical) mirror. Accordingly, a thermal imaging device which uses a small mirror has a number of benefits over thermal imaging devices which use traditional larger, bulky mirrors.

Typically the detector is a detector which provides an internal gain to (typically electrical) signals (typically an electrical current) generated in response to received radiation (typically an internal gain of more than 1, typically an internal gain of more than 10, in some cases an internal gain of more than 50). For example, as mentioned above, the detector may be an avalanche photodiode. This is particularly useful when the mirror device is a microelectromechanical mirror because the small size of the microelectromechanical mirror limits the quantity of radiation it can reflect onto the detector. The internal gain of the detector helps to overcome this small signal size by increasing the signal to noise ratio. Alternatively, for a given required signal to noise ratio, a smaller avalanche photodiode can be provided than an equivalent regular photodiode. Avalanche photodiodes typically also have fast response times so they can be re-used quickly. This allows the avalanche photodiode to measure incoming radiation over a range of entrance pupil locations more quickly than a detector with a slower response time. Thus, avalanche photodiodes can be used to form pixels in order to provide high resolution images and accurate temperature measurements.

It may be that the thermal imaging device comprises a transimpedance amplifier configured to receive electrical current signals from the detector (e.g. an avalanche photodiode) and to convert the received electrical current signals to voltage signals (and to provide amplification).

It may be that the detector is configured to detect (electromagnetic) radiation having a wavelength of less than 2 μm, or less than 1.5 μm, typically greater than 800 nm, to thereby generate signals indicative of the temperature of (at least a portion of, typically a plurality of portions of) the object being imaged. Detecting radiation at such (shorter) wavelengths can lead to reduced errors caused by unknown target emissivity. Alternatively, it may be that the detector is configured to detect (electromagnetic) radiation having a wavelength of greater than 2 μm.

It may be that the detector comprises a multi-spectral detector. It may be that the detector comprises a plurality of radiation receiving layers, each of the said radiation receiving layers being configured to receive, and to generate (typically electrical) signals responsive to, incoming radiation of a different wavelength (or a different range of wavelengths) from the other radiation receiving layers of the said plurality. It may be that the radiation receiving layers of the said plurality are arranged together in a stack. Typically the radiation receiving layers of the said plurality are aligned with each other along an axis, but axially offset from each other along that axis. It may be that the radiation receiving layers of the said plurality are arranged to each receive radiation of the respective different wavelengths to which they are responsive from a common incoming beam of radiation. This allows a wavelength dependent image to be derived by combining the signals from each of the radiation receiving layers. Achieving a wavelength dependent image in this way is significantly less expensive than by a conventional multi-spectral camera.

It may be that the plurality of radiation receiving layers comprises a first radiation receiving layer comprising or consisting of a first semiconductor material and a second radiation layer axially offset from the first radiation receiving layer and comprising or consisting of a second semiconductor material different from the first semiconductor material. It may be that the plurality of radiation receiving layers comprises a first radiation receiving layer comprising or consisting of a first semiconductor material of a first thickness (the thickness typically being parallel or at least substantially parallel to the axis along which the radiation receiving layers are arranged) and a second radiation receiving layer axially offset from the first radiation receiving layer and comprising or consisting of the first semiconductor material of a second thickness different from the first thickness.

Typically the detector is configured to provide (typically separate) signals from each of the radiation receiving layers in response to incoming radiation. It may be that the thermal imaging device is further configured to derive (and typically output and/or store in a memory data representing) a wavelength dependent thermal image from the (typically separate) signals output from each of the radiation receiving layers. It may be that the thermal imaging device is configured to provide separate signals from each of the radiation receiving layers in response to incoming radiation and to combine the said separate signals to thereby provide a wavelength dependent thermal image from the said separate signals.

It may be that one or more of the said plurality of radiation receiving layers are transparent or substantially transparent to radiation having a wavelength greater than a wavelength range of radiation to which the respective layer is responsive to generate (typically electrical) signals. For example, it may be that an outer (e.g. exposed) radiation receiving layer (e.g. which incoming radiation encounters first) is transparent or substantially transparent to radiation having a wavelength greater than a wavelength range of radiation to which the said outer layer is responsive to thereby generate (typically electrical) signals and inside a wavelength range of radiation to which an inner radiation receiving layer (e.g. which incoming radiation encounters second) is responsive to thereby generate (typically electrical) signals. Thus, radiation of a particular wavelength range can pass through a first (e.g. exposed) radiation receiving layer relatively unattenuated and be received by a second radiation receiving layer beneath the first.

It may be that the thermal imaging device comprises one or more optical elements (typically comprising one or more lenses) configured to magnify an angle of reflection of radiation provided by the mirror device (typically as viewed through an entrance aperture of the thermal imaging device). Typically the said one or more optical elements comprises a multi-element optical arrangement (typically comprising a plurality of lenses, such as a group of lenses in an inverse telephoto arrangement). It may be that the objective comprises the one or more optical elements. It may be that the said one or more optical elements comprise one or more lenses (typically comprising a plurality of lenses, such as a group of lenses in an inverse telephoto arrangement). It may be that the one or more lenses are provided between an entrance aperture of the thermal imaging device (through which radiation from the object enters the thermal imaging device) and the mirror device. Thus, the said one or more optical elements allow a relatively smaller angle of tilt applied to the mirror device to move the entrance pupil of the thermal imaging device over a relatively larger distance. This can help to overcome limitations on a physical tilting range of the mirror device (i.e. limitations on the amount by which the mirror device can tilt about an axis or about one or more of two orthogonal axes) to allow the entrance pupil to be scanned over a wider range of angles than would be permitted by the steerable range of the mirror device itself, thus increasing the field of view of the thermal imaging device.

A second aspect of the invention provides a method of determining thermal image data, comprising:
steering a mirror device forming part of an optical system, the mirror device being arranged in relation to a detector (the mirror device typically being configured to reflect incoming radiation onto the detector), wherein a position of the mirror device controls a location of an entrance pupil of an optical system;
receiving radiation at the detector and outputting a detector signal in dependence thereon indicative of a temperature of a portion of an object corresponding to the location of the entrance pupil.

It may be that the method comprises quantitatively measuring the temperature of (at least a portion of, typically each of a plurality of portions of) an object being imaged, typically from the said detector signals.

Typically the method comprises steering the mirror device to thereby scan the entrance pupil over a plurality of locations. It may be that the method comprises receiving radiation at the detector and outputting detector signals in dependence thereon indicative of temperatures of respective portions of the object corresponding to the said locations of the entrance pupil. It may be that the method comprises obtaining detector signals at each of the said plurality of locations of the entrance pupil to thereby generate a thermal image of an object. It may be that the method comprises outputting detector signals in response to radiation received at each of the respective locations of the entrance pupil, the detector signals being indicative of a temperature of a portion of the object corresponding to the respective location of the entrance pupil.

It may be that the optical system is provided with a substantially constant etendue (or optical throughput) for all of the entrance pupil locations of the said plurality.

It may be that the method comprises maintaining a substantially constant etendue (or optical throughput) of the optical system for all entrance pupil locations of the said plurality.

Typically an objective is provided. Typically the method comprises the objective collecting incoming radiation from the object and directing a portion thereof onto the steerable mirror device. Typically the method comprises the objective converging the collected radiation (typically to provide a cone of collected radiation) such that a portion of the collected radiation is directed onto the steerable mirror device. Typically the mirror device is configured to reflect radiation received from the objective onto the detector.

Typically for each of the said plurality of entrance pupil locations, a (typically theoretical) maximum cone of radiation which can be received and reflected by the mirror device onto the detector (typically independent of the objective) is within a (typically theoretical) maximum cone of collected radiation which can be provided by the objective (typically independent of the mirror device), typically to thereby provide a substantially constant etendue of the optical system for all entrance pupil locations of the said plurality of entrance pupil locations.

Typically the method comprises steering the steerable mirror device to thereby scan the entrance pupil over the said plurality of locations such that a solid angle of the mirror device from the field stop (or a projection of the solid angle of the mirror device from the field stop onto the exit aperture of the objective, typically along the principal optical axis of the (typically theoretical) maximum cone of radiation which can be received and reflected onto the detector by the mirror device) is within (typically such that it does not fill) an (or the) exit aperture of the objective for each of the said plurality of entrance pupil locations, typically to thereby provide a substantially constant etendue of the optical system for all entrance pupil locations of the said plurality.

It may be that the method comprises steering the mirror device by rotation of the mirror device about one or more axes, but more typically the method comprises steering the mirror device by tilting the mirror device about an axis or (e.g. independently) about each of two orthogonal axes. It may be that the method comprises exerting an electric field on the mirror device to thereby tilt the mirror device to a desired angle or direction. It may be that the method comprises continuously steering the mirror device to thereby continuously scan the entrance pupil between the said plurality of entrance pupil locations.

It may be that the method comprises:
steering the detector to a first entrance pupil location of the optical system;
controlling the detector to output a first detector signal indicative of the temperature of a first portion of the object.

It may be that the method comprises:
steering the detector to a second entrance pupil location of the optical system;
controlling the detector to output a second detector signal indicative of the temperature of a second portion of the object.

It may be that the method comprises steering the mirror device to scan the location of the entrance pupil amongst a plurality of positions.

It may be that the method comprises receiving, from the detector, a detector signal at each of the plurality of positions indicative of a temperature of the portion of the object corresponding to the location of the entrance pupil.

It may be that the mirror device is a microelectromechanical mirror.

It may be that the method comprise the detector applying an internal gain to (typically electrical) signals (e.g. an electrical current) generated in response to received radiation.

It may be that the method comprises a transimpedance amplifier receiving electrical current signals from the detector (e.g. an avalanche photodiode) and converting the received electrical current signals to voltage signals (typically amplifying the voltage signals).

It may be that the method comprises the detector detecting (electromagnetic) incoming radiation having a wavelength of less than 2 μm, or less than 1.5 μm to generate signals indicative of the temperature of (at least a portion of, typically a plurality of portions of) the object being imaged.

It may be that the detector comprises a plurality of radiation receiving layers. It may be that the method comprises each of the said radiation receiving layers receiving, and generating a (typically electrical) signal responsive to, incoming radiation of a different wavelength (or a different range of wavelengths) from the other radiation receiving layers of the said plurality. It may be that the method comprises all of the radiation receiving layers of the said plurality receiving radiation of the respective different wavelengths (or different ranges of wavelengths) from a common incoming beam of radiation.

It may be that the method comprises providing (typically separate) signals from each of the radiation receiving layers in response to incoming radiation. It may be that the method comprises deriving (and typically outputting and/or storing in a memory data representing) a wavelength dependent thermal image from the (typically separate) signals output from each of the radiation receiving layers. It may be that the method comprises providing separate signals from each of the radiation receiving layers in response to incoming radiation and combining the said separate signals to thereby provide a wavelength dependent thermal image from the said separate signals.

It may be that the method comprises transmitting through an outer (e.g. exposed) radiation receiving layer (e.g. which incoming radiation encounters first) of the said plurality radiation from an incoming radiation beam having a wavelength greater than a wavelength range of radiation to which the said outer layer is responsive to thereby generate (typically electrical) signals and inside a wavelength range of radiation to which an inner radiation receiving layer (e.g. which incoming radiation encounters second) is responsive to thereby generate (typically electrical) signals. The method may further comprise the outer radiation layer receiving, and generating (typically electrical) signals responsive to, radiation from the said incoming radiation beam having a wavelength inside a wavelength range of radiation to which the said outer layer is responsive to thereby generate (typically electrical) signals. The method may further comprise the inner radiation layer receiving, and generating (typically electrical) signals responsive to, radiation from the said incoming radiation beam having a wavelength inside a wavelength range of radiation to which the said inner layer is responsive to thereby generate (typically electrical) signals.

It may be that method comprises magnifying an angle of reflection of radiation provided by the mirror device as viewed through an entrance aperture of the thermal imaging device.

It may be that the method comprises steering the mirror device over at least 50% of its steerable range (or of its steerable range whilst still facing the objective) in order to scan the entrance pupil over the said plurality of locations.

It may be that the said plurality of locations of the entrance pupil together provide a horizontal angle of view of at least 10° and/or a vertical angle of view of at least 10°.

A third aspect of the invention provides computer software which, when executed by a computer, is arranged to perform a method according to the second aspect of the invention.

A fourth aspect of the invention provides the computer software of the third aspect of the invention stored on a (typically non-transitory) computer readable medium.

A fifth aspect of the invention provides an apparatus or method substantially as described herein with reference to the accompanying drawings.

It will be understood that any of the features of any of the aspects of the invention described herein may also be optional or preferred features of any of the other aspects of the invention described herein where appropriate. For example, features of aspects of the invention relating to apparatus may correspond to features of the invention relating to a method and vice versa.

### BRIEF DESCRIPTION OF THE DRAWINGS

Embodiments of the invention will now be described by way of example only, with reference to the accompanying figures, in which:

FIG. 1 is an illustration of a thermal imaging device according to an embodiment of the invention;

FIG. 2 is a schematic illustration of a thermal imaging device according to an embodiment of the invention;

FIG. 3 shows a method according to an embodiment of the invention;

FIG. 4 is an illustration of an object in relation to a plurality of locations according to an embodiment of the invention;

FIG. 5 is an illustration of a multi optical element arrangement for magnifying a tilt angle of a steerable mirror device; and;

FIG. 6 schematically illustrates a multi-spectral detector comprising a plurality of radiation receiving layers.

### DETAILED DESCRIPTION OF THE INVENTION

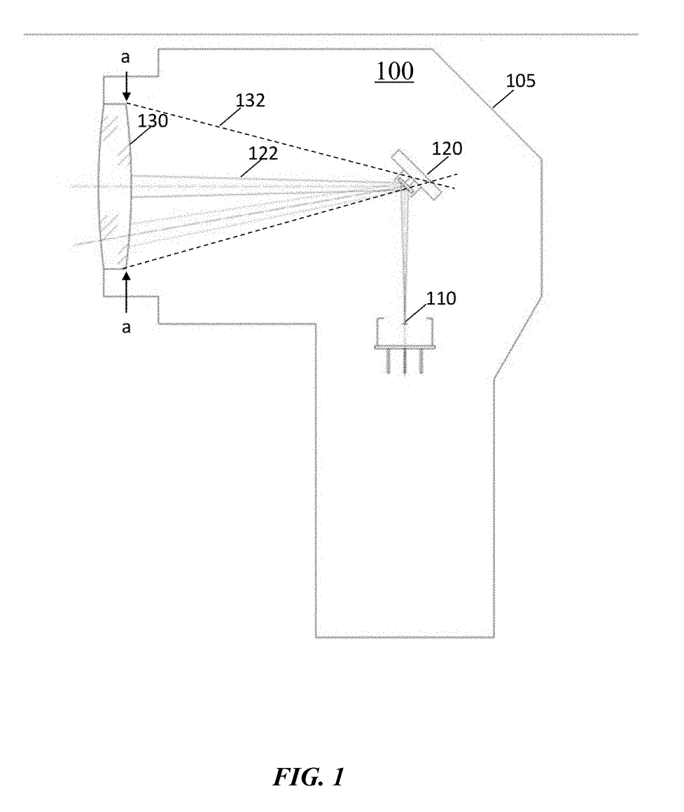

FIG. 1 illustrates a thermal imaging device 100 according to an embodiment of the invention. The thermal imaging device 100 is arranged to provide thermal data indicative of temperature over a region of an object. The thermal data is indicative of the temperature at each of a plurality of locations distributed over the region of the object, as will be explained. The thermal imaging device advantageously provides accurate measurement of the temperature at each of the locations and combines a plurality of individual measurements in order to form the thermal data.

The thermal imaging device 100 comprising a housing 105 within which components of the device 100 are located. The thermal imaging device 100 comprises a detector 110, a steerable device 120 and a lens 130 (which typically acts as an objective of the thermal imaging device 100). The components form an imaging system of the thermal imaging device 100. It will be appreciated that the thermal imaging device 100 may comprise one or more of lenses, masks and baffles other than those illustrated in FIG. 1.

The detector 110 is arranged to, in use, receive radiation from an object via the lens 130 and to output a detector signal corresponding to the received radiation. The detector 110 may be a single-pixel detector i.e. a detector which provides a single measurement value corresponding to the radiation falling thereon. In the arrangement of FIG. 1, the detector 110 forms a field stop of the imaging system, wherein edges of the detector 110 define corresponding edges of the field stop. However, in other embodiments, a mechanical aperture may be provided over the detector which forms the field stop. The detector 110 may be a photodiode and, in some embodiments, an avalanche photodiode 110.

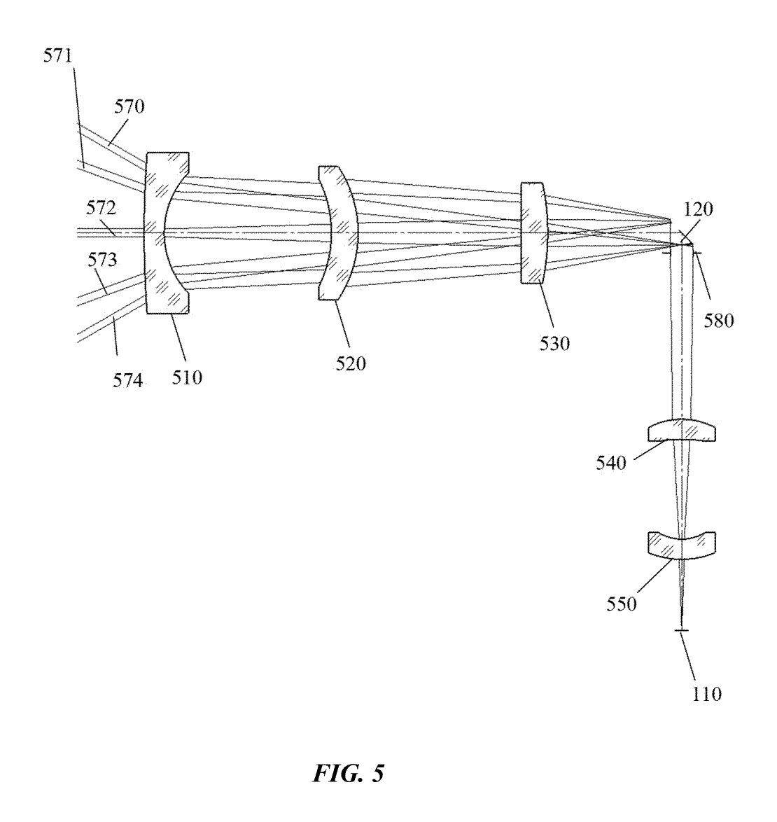

The steerable device 120 is arranged in relation to the detector 110. The steerable device 120 is arranged to receive from the lens 130 a portion of the incoming radiation from the object collected and converged by the lens 130 and to reflect it toward the detector 110. In the arrangement of FIG. 1, the steerable device 120 is arranged to form an aperture stop. However, it may be that a separate aperture stop may be provided (e.g. by way of a mechanical aperture between the steerable device 120 and the detector 110 as shown in FIG. 5 and described below) which limits the theoretical maximum cone of radiation which the steerable device 120 can receive and reflect towards the detector 110 (independent of the objective).

The steerable device 120 is operable to control an angle of the device with respect to the detector 110, thereby controlling a location of an entrance pupil of the imaging system upon the lens 130. The location of the entrance pupil corresponds to a location upon the object from which radiation is received by the thermal imaging device 100. Thus, by varying the location of the entrance pupil to select a different portion of the object, the detector 110 is caused to output the detector signal indicative of a temperature of the respective portions of the object.

In order to build up a thermal image of an object, the steerable device 120 is steered to thereby scan the entrance pupil over a plurality of locations, and at each of the locations the detector 110 is caused (by incoming radiation received and reflected onto the detector by the steerable device 120) to output a detector signal indicative of a temperature of a respective portion of the object.

As shown in FIG. 1, it may be that the theoretical maximum cone 132 of collected radiation which can be provided by the lens 130 (independent of the steerable device 120) has a half angle which is greater than the half angle of the theoretical maximum cone 122 of radiation which can be received and reflected onto the detector 110 by the steerable device 120 (independent of the lens 130). When the steerable device 120 is steered to thereby scan the entrance pupil, the theoretical maximum cone 122 of radiation which can be received and reflected onto the detector 110 also moves in dependence on the location of the entrance pupil. In this case, for each entrance pupil location of the said plurality, the theoretical maximum cone 122 of radiation which can be received and reflected onto the detector 110 by the steerable device 120 is within the theoretical maximum cone 132 of collected radiation which can be provided by the lens 130. This maintains a substantially constant (preferably a constant) etendue (or optical throughput) of the imaging system of the thermal imaging device 100 for all entrance pupil locations of the said plurality. This allows the thermal imaging device 100 to form radiometrically accurate thermal images of the object being imaged for each of the entrance pupil locations of the said plurality, thereby allowing the thermal imaging device 100 to perform accurate quantitative temperature measurements of a plurality of portions of the object being imaged. Indeed, the thermal imaging device may be configured to derive quantitative temperature measurements of one or more portions of the object being imaged from the thermal data. The thermal imaging device may further be configured to output quantitative temperature measurements of one or more portions of the object being imaged derived from the thermal data (e.g. to a display of the thermal imaging device). The thermal imaging device may also be configured to generate and output a thermal image derived from the thermal data.

It will also be understood from FIG. 1 that it may be that the solid angle of the lens 130 from the field stop (the field stop being provided by the detector 110 in this embodiment) is greater than the solid angle of the steerable device 120 from the field stop. Similarly, the solid angle of the steerable device 120 from the field stop (or a projection of the solid angle of the steerable device 120 from the field stop onto the exit aperture ‘a’ of the lens 130 along the principal optical axis of the theoretical maximum cone 122 of radiation which can be received and reflected onto the detector 110 by the steerable device 120) is within (and does not fill) the exit aperture a of the lens 130 for each entrance pupil location of the said plurality. Put another way, typically the exit pupil of the thermal imaging device 100 is within the exit aperture of the lens 130 for each entrance pupil location of the said plurality. As above, these features help to ensure that the etendue of the imaging system remains substantially constant (preferably constant) for all entrance pupil locations of the said plurality, allowing the thermal imaging device 100 to obtain radiometrically accurate thermal images.

In order to provide the thermal imaging device with as wide a field of view as possible, it is preferable for the plurality of entrance pupil locations to cover a wide range of entrance pupil locations, preferably encompassing entrance pupil locations throughout the entire steerable range (or of its steerable range whilst still facing the objective) through which it is possible for the steerable device 120 to steer. Preferably the entrance pupil locations through which the entrance pupil is scanned provides the thermal imaging device with horizontal and vertical angles of view of at least 10°, more preferably at least 20° and more preferably at least 30°, yet more preferably more than 40°. However, in some embodiments, it may be that the plurality of entrance pupil locations encompasses entrance pupil locations throughout only part (e.g. less than 100% but more than 50%, more than 70%, more than 80% or more than 90%) of the steerable range through which it is possible for the steerable device 120 to steer.

In one embodiment, the steerable device 120 is a micro-mirror device, although it will be realised that other devices which have an angle of reflection controlled responsive to a signal may be used. In some embodiments, the steerable device 120 has a reflective surface having a diameter of less than 10 mm, typically less than 6 mm, more typically less than 5.5 mm, more typically less than 4 mm. In some embodiments the steerable device 120 is a microelectromechanical (MEMS) mirror. One or more signals provided to the MEMs mirror control one or both of an angle and a direction of the mirror by means of an electric field exerted on the mirror.

By reducing the size of the mirror, the resolution of the thermal imaging device can be increased and the thermal imaging device can be made more portable and compact. In addition, it is easier to ensure that the maximum cone 122 of radiation which can be received and reflected by the steerable device 120 onto the detector 110 remains within the maximum cone 132 of collected radiation which can be provided by the lens 130 to thereby provide the imaging system of the thermal imaging device 100 with a substantially constant (preferably constant) etendue (or optical throughput) for all entrance pupil locations of the said plurality. However, the magnitudes (and therefore the signal to noise ratio) of signals received by the detector 110 are reduced as less radiation is received and reflected by the steerable device 120 onto the detector than with a larger mirror. In addition, as the thermal imaging device 100 detects radiation emitted by an object being imaged itself (rather than radiation from a radiation source configured to emit a beam of radiation the intensity of which can be readily controlled), it is not readily possible to overcome the signal to noise ratio reduction simply by increasing the intensity of the signal. To overcome this limitation, by increasing the signal to noise ratio, it may be that the detector 110 comprises or consists of a detector which applies an internal gain (preferably a gain of 10 or more, 20 or more or 50 or more) to signals generated in response to incoming radiation. For example, as mentioned above, the detector may comprise or consist of an avalanche photodiode. Avalanche photodiodes have the additional benefit of fast response times, which can enable higher resolution thermal images to be generated more quickly, particularly when the detector is a single-pixel detector. Avalanche photodiodes also have their capacitances lowered by a heavy applied reverse bias, which reduces noise (particularly at higher frequencies) compared to regular photodiodes. When the detector 110 comprises an avalanche photodiode, it may be that the thermal imaging device further comprises a transimpedance amplifier configured to receive a current signal from the avalanche photodiode and to amplify it and convert it to a voltage signal. Transimpedance amplifiers are particularly suited for use with avalanche photodiodes because they can convert the photocurrent from the avalanche photodiode into a voltage whilst forcing them to remain at the same voltage. This results in a linear relationship between power received (irradiance) and voltage output from the amplifier.

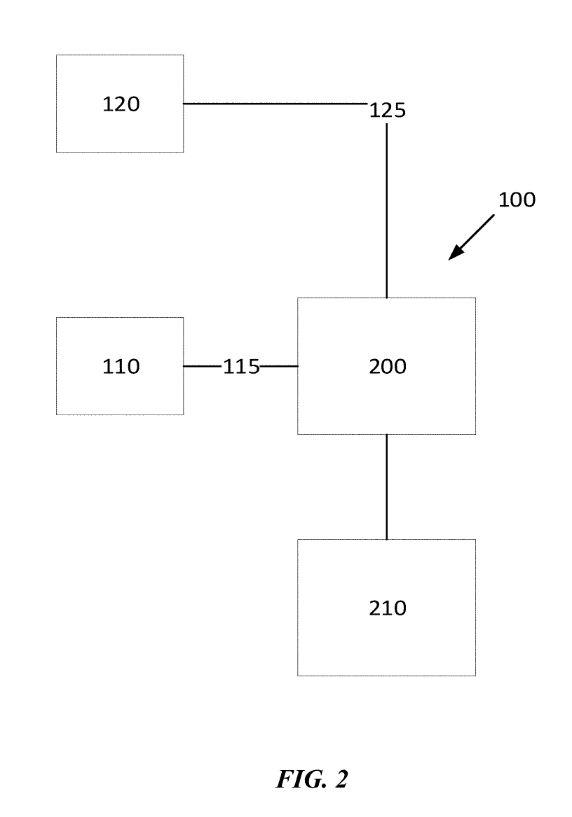

FIG. 2 schematically illustrates the thermal imaging device 100. As noted above, the thermal imaging device 100 comprises the detector 110 and the steerable device 120. In use the detector is arranged to output the detector signal 115 indicative of the radiation falling thereon. The steerable device 120 is arranged to be steered responsive to a steering signal 125.

The thermal imaging device 100 further comprises a control unit 200 which is arranged to control the detector 110 to output the detector signal 115. The control unit 200 provides the steering signal 125 to the steerable device 120. The thermal imaging device 100 comprises a memory unit 210 associated with the control unit 200 for storing the thermal data therein. The control unit 200 is arranged to operatively output a steering signal 125 to the steerable device 120 indicative of one or both of the angle and the direction of the steerable device 120, such as the MEMs mirror 120, to control the location of the entrance pupil on the lens 130, thereby selecting a portion of the object within the region of the object to be thermally imaged.

The control unit 200 is arranged to receive the detector signal 115 from the detector 110. In some embodiments, although not specifically shown in FIG. 2, the control unit 200 is arranged to output a signal to the detector 110 to cause the detector 110 to provide the detector signal 115 indicative of radiation falling thereon. Thus the control unit 200 may, in some embodiments, control when the detector signal is received such that the position of the entrance pupil, and thus location about the object, corresponding to the detector signal 115 is known. As will be explained, in some embodiments, the control unit 200 is arranged to control the steerable device 120 and detector 110 to receive sequence of detector signals 115 each indicative of the temperature of a respective portion of the object corresponding to a plurality of positions of the entrance pupil.

The control unit 200 is arranged to store the thermal data in the memory unit 210. The thermal data indicative of a temperature of a location of the object is stored in the memory unit 210. Each piece or item of thermal data may be stored in the memory unit 210 associated with location information indicative of the location of the object from which the thermal data is indicative of the temperature. The location information may be indicative of the location of the entrance pupil corresponding to the detector signal 115 with which the thermal data is associated.

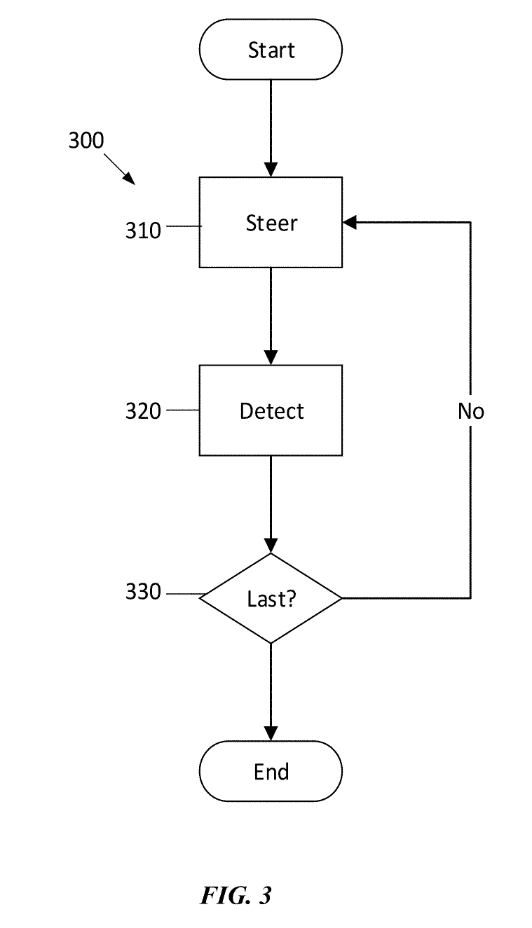

FIG. 3 illustrates a method 300 according to an embodiment of the invention. The method 300 is a method of determining thermal image data corresponding to an object. The method 300 may be performed by the apparatus described above and illustrated in FIGS. 1 and 2.

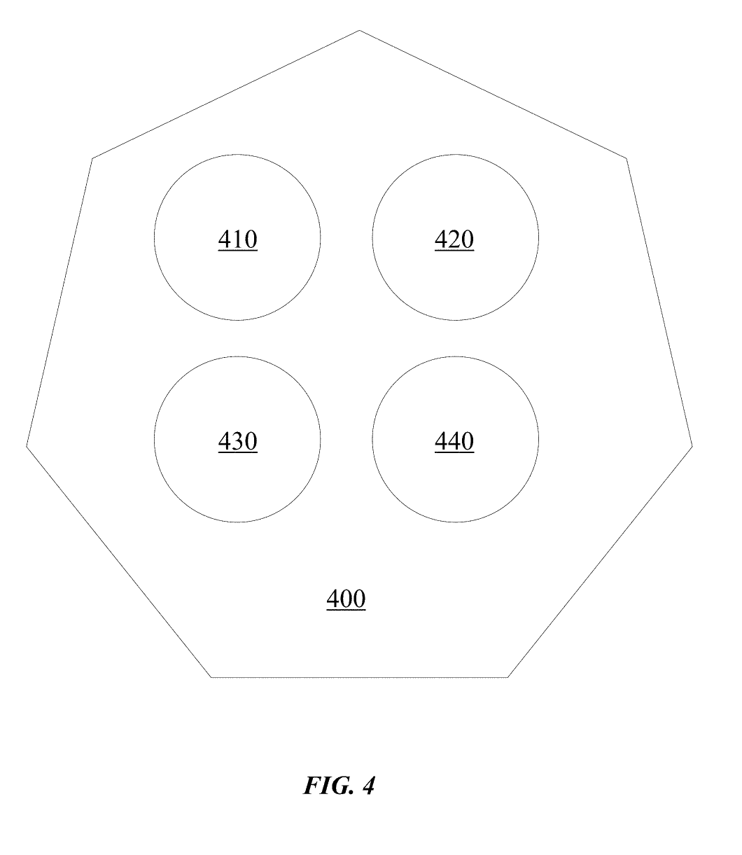

The method 300 comprises a step 310 of steering the steerable device to a location. In step 310 the control unit 200 may output one or more steering signals 125 to cause the steerable device 120, such as the MEMs mirror 120, to move to a desired angle with respect to the detector 110. Thus in step 310 the location of the entrance pupil upon the lens 130 is determined. Consequently, the apparatus is arranged to receive radiation from a location upon the object corresponding to the entrance pupil location. Referring to FIG. 4 which illustrates an example object 400. A first location 410 upon the object 400 is illustrated which may be selected in step 310 by the control unit 200 outputting one or more steering signals 125. It will be appreciated that the location 410 on the object 400 shown in FIG. 4 is merely an example. The first location 410 may, for example, be selected in a first iteration of step 310. As a result of step 310 radiation originating from the location 410 selected about the object 400 by the location of the entrance pupil enters the apparatus 100 through the lens 130 and is reflected to the detector 110 by the steerable device 120.

In step 320 a temperature of the object 400 at the location selected in step 310 is determined. Step 320 may comprise the control unit 200 outputting one or more signals to the detector 110 to trigger the detector to output the detector signal 115. In response, the detector 115 is arranged to output the detector signal 115 which is received by the control unit 200. In step 320 the control unit 200 may store in the memory unit 210 thermal data indicative of the received detector signal 115. As noted above, the thermal data may be associated with location data indicative of the location 410 upon the object 400.

In step 330 it is determined whether the location selected in step 310 is a last, or final, location of the object 400 from which the temperature is to be determined (e.g. corresponding to a last, or final, entrance pupil location of the said plurality). For example, in FIG. 4 a plurality of locations, in particular four locations 410-440 about the object 400, are illustrated. In FIG. 4 the four locations 410-440 are spatially separated i.e. do not overlap. However it will be appreciated that the plurality of locations 410-440 may partly overlap. If, in step 330 the location is not the final location of the plurality of locations, the method returns to step 310 where a next or further location is selected, such as a second location 420 as illustrated as an example in FIG. 4. Thermal data corresponding to the second location 420 is then stored in the memory unit 210 in step 320. Steps 310-330 may be repeated until thermal data corresponding to all of the plurality of locations 410-440 is stored in the memory unit 210. In some embodiments, steps 310-330 may be performed to raster-scan the object 400. The raster scan of the object 400 may comprise the temperature of a first plurality of locations being determined along a first row, which may be generally horizontal, before the temperature of a second plurality of locations is determined in a second row. Further rows of locations may be included. In this way, the temperature of the region of the object is determined. The raster scan may be repeated at one or more later points in time to determine a time-evolution of the temperature of the object 400.

Subsequent to the method 300 being performed, the thermal data stored in the memory unit 210 may be used to, for example, output a thermal image corresponding to a region of the object 400 encompassing the plurality of locations. However, in contrast to using a thermal imaging camera, the thermal image produced by an embodiment of the invention comprises thermal data having an improved accuracy due to being produced by a point or single-pixel detector. This is particularly the case in embodiments in which for each of the entrance pupil locations of the said plurality the theoretical maximum cone 122 of radiation which can be received and reflected onto the detector 110 by the steerable device 120 is within the theoretical maximum cone 132 of collected radiation which can be provided by the lens 130 to thereby provide the imaging system of the thermal imaging device 100 with a substantially constant (preferably constant) etendue (or optical throughput) for all entrance pupil locations of the said plurality. As discussed above, this allows the thermal imaging device 100 to form radiometrically accurate thermal images of the object being imaged, thereby allowing the thermal imaging device 100 to perform accurate quantitative temperature measurements of one or more portions of the object being imaged.

It will be appreciated that FIG. 3 describes operation of the apparatus of FIG. 1 in a ‘stop-and-stare’ mode in which the temperature of discrete locations 410-440 of the object 400 is determined and thermal data corresponding thereto stored in the memory unit 210. However it will be appreciated that the apparatus 100 may be used in a ‘free-running’ configuration. In such a configuration the control unit 200 controls the steerable device 120 to continuously move such that the entrance pupil continuously moves across the lens 130. As a result, the location about the object 400 from which radiation is received also continuously moves. In some embodiments, the detector signal 115 may be a voltage indicative of the temperature as the location continuously moves across the object 400. The apparatus 100 may comprise an analog-to-digital convertor (ADC) arranged to receive the detector signal 115 voltage and to output digital data corresponding to the detector signal 115 to the control unit 200. The control unit 200 divides the received data into thermal pixel data and periodically stores in the memory unit 210 data corresponding to the received digital data.

In some embodiments the steerable device 120 is steered by rotation of the mirror about one or more axes, but more typically the steerable device 120 is steered by tilting the mirror about an axis (for a one dimensional image) or (typically independently) about each of two orthogonal axes (for a two dimensional image). It may be that the steerable device 120 is configured to be tilted to a desired angle or direction by an electric field exerted on the mirror (e.g. it may be that the steerable device 120 is a microelectromechanical mirror having these properties). By tilting (rather than rotating) the steerable device 120, it can be ensured that the steerable device 120 constantly images the object being imaged (rather than for example spending time viewing the internals of the thermal imaging device 100). Providing a steerable device 120 which steers by tilting rather than by rotation also makes it easier for the steerable device 120 to continuously move the entrance pupil of the thermal imaging device 100 between entrance pupil locations (i.e. to operate in the ‘free running mode’ rather than the “stop and stare” mode). This permits faster scanning of the object, enabling faster imaging. Accordingly, it may be that the thermal imaging device 100 continuously steers the mirror device to thereby continuously scan the entrance pupil between entrance pupil locations.

It will be understood that, although the objective in the embodiment of FIG. 1 is provided by a simple objective lens 130, a more complex objective may provided (e.g. comprising a plurality of lenses and/or one or more mirrors). In this case, the theoretical maximum cone of collected radiation which can be provided by the objective (a portion of which is detected by the steerable device 120) is typically a theoretical maximum cone of radiation which can be provided by a limiting lens of the objective. For example, a more complex optical arrangement than the one shown in FIG. 1 may be provided to magnify an angle of reflection of radiation provided by the steerable device 120 (typically as viewed from the entrance aperture of the objective). This allows a steerable mirror device 120 to be used which has a physically limited steerable range (e.g. the steerable mirror device 120 may be a microelectromechanical mirror having a maximum tilting angle of +/−5°) to scan the entrance pupil of the thermal imaging device over a wider range of angles at the entrance aperture of the objective. This increases the effective field of view of the thermal imaging device. An example 500 of such an optical arrangement is shown in FIG. 5, which shows a five lens optical arrangement: three lenses 510, 520 and 530 are provided to form the objective and two lenses 540, 550 are provided between the steerable device 120 and the detector 110. The lens 530 is the limiting lens of the objective in this case; as such, the theoretical maximum cone of radiation which can be received and reflected by the steerable device 120 onto the detector 110 is preferably within the maximum cone of collected radiation which can be provided by the limiting lens 530 for each of the entrance pupil locations of the said plurality.

In the example of FIG. 5, the cone 560 of radiation between the steerable device 120 and the detector 110 remains the same for all scanning positions of the steerable device 120 for all entrance pupil locations of the said plurality, the lenses 540 and 550 focusing radiation from the steerable device 120 onto the detector (regardless of the steering position of the mirror device 120). However, five different incident cones of radiation 570-574 are shown, each cone 570-574 representing the cone of radiation between the steerable device 120 and the lens 510 for a different steering position of the steerable device 120. More specifically, the tilt angle of the steerable device is adjusted about the axis extending in and out of the page in the view of FIG. 5 by 10° from the lowermost position 570 to the uppermost position 574 in FIG. 5. At the entrance aperture of the lens 510, there is a 60° difference between the angles of the principal optical axes of the cones 570 and 574 (providing a vertical angle of view of 60° in this case). This is caused by the magnification of the angle of reflection of radiation provided by the steerable device 120 by the lenses 510, 520 and 530 (which form an inverse telephoto lens group which magnify the range of possible angles of reflection of radiation provided by the steerable device 120 from +/5° to +/−30° at the entrance of the objective).

Although in the embodiments of FIG. 1 the aperture stop of the thermal imaging device 100 is provided by the steerable mirror device 120, in the arrangement of FIG. 5 a separate physical aperture stop 580 is provided between the steerable mirror device 120 and the lens 540. The purpose of the separate aperture stop 580 in this case is to restrict the size of the theoretical maximum cone of radiation which the steerable mirror device 120 can receive and reflect onto the detector 110 (independent of the objective) by blocking radiation reflected from edge portions of the reflective surface of the steerable mirror device 120 to thereby avoid edge effects. Typically the maximum cone of radiation which can be received and reflected onto the detector by the mirror device covers more than 70% of the reflective surface of the mirror device (preferably more than 80%, in some cases more than 90%), but typically less than 100% of the reflective surface of the mirror device 120.

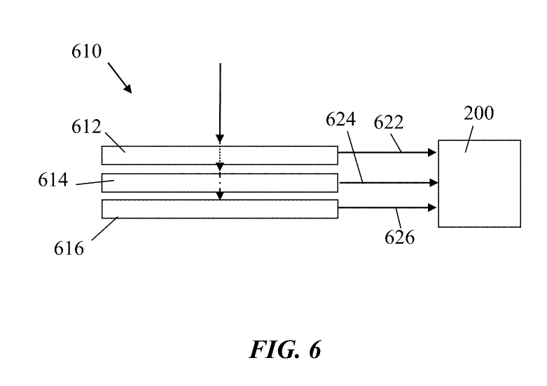

In some embodiments, the detector 110 may be replaced by a detector 610 shown in FIG. 6 which is a multi-spectral single pixel detector having a stack of three radiation receiving layers 612, 614 and 616, each of which is configured to receive, and to generate electrical signals responsive to, incoming radiation of a different wavelength (or a different range of wavelengths) from the other radiation receiving layers. The radiation receiving layers 612, 614, 616 are aligned with each other along an axis, but axially offset from each other along that axis, such that they can each receive radiation of the respective wavelength from a common beam of incoming radiation. The radiation receiving layers 612, 614, 616 are sensitive to different wavelengths of radiation by virtue of being made from different (typically semiconductor) materials or from the same materials of different thickness. In the embodiment illustrated in FIG. 6, the layers 612, 614, 616 are each of the same thickness but formed from different (typically semiconductor) materials.

In order for radiation incident on layer 612 to reach layer 614, it must be able to pass through layer 612 and for radiation to reach layer 616 it must be able to pass through layers 614 and 616. This is illustrated by the dotted arrows in FIG. 6. Accordingly, layer 612 is configured to be transparent or substantially transparent to radiation to which layers 614 and 616 are sensitive and layer 614 is configured to be transparent or substantially transparent to radiation to which layer 616 is sensitive. This can be done because wavelengths which are longer than the cut-off wavelength of layer 612 (for example) penetrates beyond the PN junction thereof and, as long as layer 612 is not too thick, it will pass out the opposite side of layer 612 to be detected by a layer (e.g. 614 or 616) having a longer cut-off wavelength.

For example, the layers 612, 614, 616 may be layers of silicon. This provides the first layer 612 with the usual silicon responsivity spectrum with an ‘effective wavelength’ (to which it is responsive) of 0.95 μm but also allows radiation of longer wavelengths (e.g. radiation with an effective wavelength of 1.05 μm) to leak through layer 612 to layer 614. Longer wavelengths penetrate further into semiconductors, hence the wavelength is shifted. Alternatively, the first layer 612 may be a silicon layer and the second layer 614 may be a InGaAs layer to provide layers 612, 614 with, for example, 1 μm and 1.2 μm effective wavelengths (to which they are responsive). The third layer 616 may be an InAs layer or an extended InGaAs for yet greater effective wavelengths. InGaAs can be ‘strained’ and its wavelength response extended into the infrared, and different arrangements of InGaAs can be provided that “cut off” at wavelengths of 1.7, 1.9, 2.1 or 2.6 μm. InAs cuts off at wavelengths of 3.4 μm. Other suitable materials include InAsSb, which cuts off at 5 μm or potentially up to 8 μm. MCT (mercury cadmium telluride) can be made to cut off at wavelengths up to 14 μm and beyond.

Separate signals 622, 624, 626 are provided from each of the radiation receiving layers 612, 614, 616 in response to incoming radiation. It may be that the control unit 200 is further configured to derive (and typically output and/or store in memory 210 data representing) a wavelength dependent thermal image by combining the signals 622, 624, 626 output from the radiation receiving layers 612, 614, 616. In this way, a wavelength dependent thermal image can be determined more cost effectively than, for example, using a traditional multi-spectral camera.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A thermal imaging device, comprising:
a detector for receiving radiation and outputting a detector signal corresponding thereto; and
a steerable mirror device arranged in relation to the detector;
wherein the steerable mirror device is steerable to scan an entrance pupil over a plurality of entrance pupil locations such that the detector outputs respective detector signals indicative of temperatures of respective portions of an object corresponding to the locations of the entrance pupil, and
wherein the thermal imaging device is configured to provide a substantially constant etendue for all of the entrance pupil locations of the plurality of entrance pupil locations.

2. The thermal imaging device of claim 1, further comprising a control unit arranged to control the detector to output a sequence of detector signals each indicative of the temperature of a respective portion of the object corresponding to the plurality of locations of the entrance pupil.

3. The thermal imaging device of claim 1, further comprising:
a steering device arranged to steer the steerable mirror device responsive to a steering signal; and
a control unit arranged to output the steering signal and a detector control signal, such that the detector outputs a first detector signal indicative of the temperature of the object with the entrance pupil at a first location and a second detector signal indicative of the temperature of the object with the entrance pupil at a second location.

4. The thermal imaging device of claim 1, wherein the detector is a single pixel detector.

5. The thermal imaging device of claim 4, wherein the detector is an avalanche photodiode.

6. The thermal imaging device of claim 1, wherein the steerable mirror device is a microelectromechanical mirror.

7. The thermal imaging device of claim 1, further comprising an objective configured to collect incoming radiation from the object and to direct a portion thereof onto the steerable mirror device, wherein the thermal imaging device is configured such that, for each of the plurality of entrance pupil locations, a theoretical maximum cone of radiation which can be received and reflected onto the detector by the steerable mirror device is within a theoretical maximum cone of collected radiation which can be provided by the objective.

8. The thermal imaging device of claim 1, further comprising:
an objective configured to collect incoming radiation from the object and to direct a portion thereof onto the steerable mirror device; and
a field stop, wherein the thermal imaging device is configured such that the solid angle of the objective from the field stop is greater than the solid angle of the steerable mirror device from the field stop.

9. The thermal imaging device of claim 1, further comprising:
an objective configured to collect incoming radiation from the object and to direct a portion thereof onto the steerable mirror device; and
a field stop, wherein, for each of the plurality of entrance pupil locations, the solid angle of the steerable mirror device from the field stop, or a projection of the solid angle of the steerable mirror device from the field stop onto an exit aperture of the objective, is within an or the exit aperture of the objective.

10. The thermal imaging device of claim 1, further comprising an objective configured to collect incoming radiation from the object and to direct a portion thereof onto the steerable mirror device, wherein the thermal imaging device is configured such that a half angle of the theoretical maximum cone of collected radiation that can be provided by the objective is greater than a half angle of the theoretical maximum cone of radiation which can be received and reflected onto the detector by the steerable mirror device.

11. The thermal imaging device of claim 1, further comprising a computer configured to quantitatively measure temperatures of one or more portions of an object being imaged by way of detector signals.

12. The thermal imaging device of claim 1, wherein the steerable mirror device is configured to be steered by tilting the steerable mirror device about an axis or about two orthogonal axes.

13. The thermal imaging device of claim 1, wherein the detector provides an internal gain to signals generated in response to received radiation.

14. The thermal imaging device of claim 1, wherein the detector comprises a plurality of radiation receiving layers, each of the radiation receiving layers of the plurality being configured to receive, and to generate signals responsive to, incoming radiation of a different wavelength or of wavelengths within a different range of wavelengths from the other radiation receiving layers of the plurality.

15. The thermal imaging device of claim 14 wherein the radiation receiving layers are arranged to each receive radiation of the respective different wavelengths to which they are responsive from a common beam of radiation.

16. The thermal imaging device of claim 14 configured to combine signals from each of the radiation receiving layers to thereby provide a wavelength dependent thermal image from the said signals.

17. The thermal imaging device of claim 1, further comprising one or more optical elements configured to magnify an angle of reflection of radiation provided by the steerable mirror device.

18. The thermal imaging device of claim 1, further comprising an aperture stop separate from the steerable mirror device.

19. The thermal imaging device of claim 18, wherein the aperture stop and the steerable mirror device are configured such that a maximum cone of radiation which can be received and reflected onto the detector by the steerable mirror device covers less than 100% of the surface area of the reflective surface of the steerable mirror device.

20. The thermal imaging device of claim 19, wherein the maximum cone of radiation does not cover edge portions of the reflective surface of the steerable mirror device.

21. A method of determining thermal image data, the method comprising:
steering a mirror device forming part of an optical system, the mirror device being arranged in relation to a detector, to thereby scan an entrance pupil of the optical system over a plurality of locations, wherein a position of the mirror device controls the location of the entrance pupil of the optical system; and
receiving radiation at the detector and outputting detector signals in dependence thereon indicative of temperatures of respective portions of an object corresponding to the locations of the entrance pupil,
wherein the optical system is provided with a substantially constant etendue for all of the entrance pupil locations of the plurality of entrance pupil locations.

22. One or more non-transitory computer readable media comprising computer executable instructions which, when executed by a computer, cause performance of the method according to claim 21.
